(19) United States
(12) Patent Application Publication
(10) Pub. No.: US 2021/0332234 A1
(43) Pub. Date: Oct. 28, 2021

(54) COMPOSITION AND THERMOPLASTIC MOLDING COMPOUND HAVING REDUCED GLOSS AND GOOD CHEMICAL RESISTANCE

(71) Applicant: Covestro Deutschland AG, Leverkusen (DE)

(72) Inventors: Andreas Seidel, (US); Sven HOBEIKA, Solingen (DE); Ralf HUFEN, Duisburg (DE); Thomas ECKEL, Dormagen (DE)

(21) Appl. No.: 16/474,329

(22) PCT Filed: Dec. 22, 2017
(86) PCT No.: PCT/EP2017/084282

§ 371 Date: Jun. 27, 2019

(51) Int. Cl. C08L 69/00

(52) U.S. Cl. CPC C08L 69/00; C08L 2205/03

(57) ABSTRACT

The invention relates to a composition for production of a thermoplastic moulding compound, wherein the composition comprises or consists of the following constituents:
A) 30% to 90% by weight of at least one polymer selected from the group consisting of aromatic polycarbonate, aromatic polyester carbonate and aromatic polyester,
B) 5% to 65% by weight of rubber-modified vinyl (co)polymer prepared by the bulk polymerization method which is free of epoxy groups,
C) 0.5% to 10% by weight of a block or graph polymer containing structural elements deriving from styrene and at least one epoxy-containing vinyl monomer,
D) 0% to 20% by weight of one or more further additives,
   wherein component C has a weight ratio of structural elements deriving from styrene to those deriving from epoxy-containing vinyl monomer of 100:1 to 1:1,
      and to a process for producing a moulding compound from the composition, to the use of the composition or the moulding compound for production of mouldings, and to the mouldings themselves.

The present invention relates to a composition, especially a polycarbonate composition, for production of a thermoplastic moulding compound, to a process for producing the thermoplastic moulding compound, to the moulding compound itself, to the use of the composition or moulding compound for production of mouldings, and to the mouldings themselves.

Polycarbonate compositions have been known for a long time, and these materials are used to produce mouldings for a wide variety of applications, for example in the automobile sector, for rail vehicles, for the construction sector, in the electrical/electronics sector and in domestic appliances. The quantity and nature of the constituents in the formulation can be varied to achieve a wide range of modification of the compositions, and thus also of the resultant mouldings, so that the thermal, rheological and mechanical properties of these are appropriate to the requirements of each application.

As well as the properties mentioned, a matte surface impression of the mouldings that have been produced by the injection moulding method, for example, is desirable for many applications in the sector of unpainted components, particularly in the automotive sector. Moreover, owing to the lack of a protective paint layer, it is important that the mouldings have good stability to the effect of chemicals.

Numerous documents disclose that use of copolymers having functional groups can achieve a reduction in surface gloss.

DE 3413751 A1 discloses thermoplastic moulding compounds comprising polycarbonate, graft polymers, rubber-free copolymers and optionally copolymer rubbers, and optionally standard additives, which are characterized in that the rubber-free copolymers incorporate epoxy compounds in polymerized form. The mouldings produced from the moulding compounds are notable for a high thermal stress limit, improved heat distortion resistance coupled with good toughness, and a homogeneous matt surface quality.

EP 1 069 156 B1 discloses flame-retardant thermoplastic compositions comprising polycarbonate, styrene graft polymer, styrene copolymer, SAN-grafted polycarbonate or polycarbonate-grafted SAN and phosphoric esters. The compositions have improved flame retardancy and improved mechanical properties. These compositions are suitable for housings for electrical or electronic appliances.

U.S. Pat. No. 4,885,335 A discloses compositions comprising polycarbonate, an acrylonitrile-styrene-acrylate copolymer and a glycidyl methacrylate copolymer for gloss reduction.

EP 0 375 941 A1 discloses a thermoplastic having good physical properties, composed of polycarbonate, ABS and a glycidyl methacrylate copolymer. The mouldings have low surface gloss.

EP 0 549 205 B1 discloses polycarbonate resin compositions having low gloss and excellent mechanical strength. The compositions comprise polycarbonate, a styrene resin, an addition polymer having units derived from glycidyl methacrylate and an organic acid.

Also described is the way in which the use of functional groups can achieve a modified phase structure and consequently as improved profile of properties.

For instance, EP 1 854 842 B1 discloses styrene resin compositions comprising polycarbonate, a styrene-based resin, for example ABS, a modified styrene-based polymer containing vinyl-based monomer units with functional groups. The compositions are suitable for processing by injection moulding, have excellent mechanical properties, flowability, chemical resistance and galvanizability, and can easily be rendered flame-retardant.

However, there is no disclosure in the documents from the prior art as to how the overall profile of properties needed for unpainted applications can be achieved, namely a matte surface impression and simultaneously good chemical resistance.

It was therefore desirable to provide a composition for the production of a moulding composition from which it is possible to produce mouldings which, even without surface painting, have low surface gloss, preferably also in the case of different processing temperatures, and very good stability to chemicals.

A measure that can be used for chemical resistance is the stress cracking resistance (ESC) in rapeseed oil at room temperature according to DIN EN ISO 22088 (2006 version). Preferably, given an external edge fibre elongation of 2.4%, the time before fracture failure should be at least 15 hours, further preferably at least 24 hours.

It has now been found that, surprisingly, a composition and a thermoplastic moulding compound produced therefrom, wherein said composition comprises or consists of the following constituents:
A) 30% to 90% by weight, preferably 40% to 80% by weight, more preferably 50% to 75% by weight, of at least one polymer selected from the group consisting of aromatic polycarbonate, aromatic polyester carbonate and aromatic polyester,
B) 5% to 65% by weight, preferably 10% to 50% by weight, more preferably 15% to 45% by weight, of rubber-modified vinyl (co)polymer prepared by the bulk polymerization method which is free of epoxy groups,
C) 0.5% to 10% by weight, preferably 1% to 8% by weight, more preferably 2% to 7% by weight, of a block or graft polymer containing structural elements deriving from styrene and at least one epoxy-containing vinyl monomer,
D) 0% to 20% by weight, preferably 0.1% to 15% by weight and more preferably 0.2% to 10% by weight of one or more further additives,

wherein component C has a weight ratio of structural elements deriving from styrene to those deriving from epoxy-containing vinyl monomer of 100:1 to 1:1, preferably of 10:1 to 1:1, further preferably of 5:1 to 1:1, most preferably of 3:1 to 1:1,

has the desired profile of properties.

Component B consists of rubber-containing graft polymers prepared by the bulk. polymerization process as component B1 and optionally rubber-free vinyl (co)polymers as component B2.

For some applications, for example in the automobile interior sector, it is also desirable that the moulding compounds have a small proportion of volatile compounds. It is particularly desirable that the moulding compounds have a low content of monomeric bisphenols, preferably of monomeric hisphenol A. The content of monomeric bisphenols is to be less than 25 ppm, further preferably less than 20 ppm and more preferably less than 15 ppm.

Component A

Polycarbonates for the purposes of the present invention are either homopolycarbonates or copolycarbonates and/or polyester carbonates; the polycarbonates can, as is known, be linear or branched. It is also possible in accordance with the invention to use mixtures of polycarbonates.

The thermoplastic polycarbonates, including the thermoplastic aromatic polyester carbonates, have average molecular weights Mw determined by GPC (gel permeation chromatography in methylene chloride with a polycarbonate standard) of 15 000 g/mol to 50 000 g/mol, preferably of 20 000 gimol to 35 000 g/mol, more preferably of 23 000 g/mol to 33 000 gmol.

A portion of up to 80 mol %, preferably from 20 mol % to 50 mol %, of the carbonate groups in the polycarbonates used in accordance with the invention may have been replaced by aromatic dicarboxylic ester groups. Polycarbonates of this type that incorporate not only acid radicals derived from carbonic acid but also acid radicals derived from aromatic dicarboxylic acids in the molecular chain are referred to as aromatic polyester carbonates. For the purposes of the present invention, they are covered by the umbrella term “thermoplastic aromatic polycarbonates”.

The polycarbonates are prepared in a known manner from diphenols, carbonic acid derivatives, optionally chain terminators and optionally branching agents, but for preparation of the polyester carbonates a portion of the carbonic acid derivatives is replaced by aromatic dicarboxylic acids or derivatives of the dicarboxylic acids according to the extent to which the carbonate structural units are to be replaced by aromatic dicarboxylic ester structural units in the aromatic polycarbonates.

Dihydroxyaryl compounds suitable for the preparation of polycarbonates are those of the formula (1)

HO—Z—OH (1)

in which
Z is an aromatic radical which has from 6 to 30 carbon atoms and may contain one or more aromatic rings, may be substituted and may contain aliphatic or cycloaliphatic radicals or alkylaryl radicals or heteroatoms as bridging elements.

Z in formula (I) is preferably a radical of the formula (2)

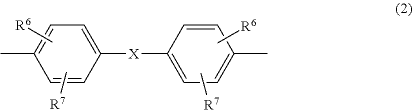

in which
R⁶ and R⁷ are independently H, C₁- to C₁₈-alkyl-, C₁- to C₁₈-alkoxy, halogen such as Cl or Br or in each case optionally substituted aryl or aralkyl, preferably II or C₁- to C₁₂-alkyl, more preferably H or C₁- to C₈-alkyl and even more preferably H or methyl, and
X is a single bond, —SO₂—, —CO—, —O—, —S—, C₁- to C₆-alkylene, C₂- to C₅-alkylidene or C₅- to C₆-cycloalkylidene which may be substituted by C₁- to C₆-alkyl, preferably methyl or ethyl, or else is C₆- to C₁₂-arylene, optionally fused to other aromatic rings containing heteroatoms.

X is preferably a single bond, C₁- to C₅-alkylene, C₂- to C₅-alkylidene, C₅- to C₆-cycloalkylidene, —O—, —SO—, —CO—, —S—, —SO₂—

or is a radical of the formula (2a)

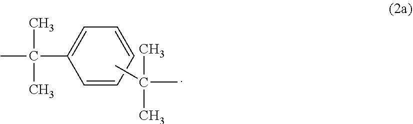

Examples of dihydroxyaryl compounds (diphenols) are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and ring-alkylated and ring-halogenated compounds derived therefrom.

Examples of diphenols suitable for the preparation of the polycarhonates to be used in accordance with the invention are hydroquinone, resorcinol, dihydroxydiphenyl, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes and alkylated, ring-alkylated and ring-halogenated compounds derived therefrom.

Preferred diphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,-bis[2-(3.5-dimethyl-4-hydroxyphenyl)-2-propyl]benene and 1,1-bis(4-hydroxyphenyl)-3,3,5-trimethylcyclohexane (bisphenol TMC).

Particularly preferred diphenols are 4,4′-dihydroxydiphenyl, 1,1-bis(4-hydroxyphenyl)phenylethane, 2,2-bis(4-hydroxyphenyl)propane (bisphenol A), 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethyleyclohexane (bisphenol TMC).

2,2-Bis(4-hydroxyphenyl)propane (bisphenol A) is especially preferred.

These and further suitable diphenols are described, for example, in U.S. Pat. Nos. 2,999,835 A, 3,148,172 A, 2,991,273 A, 3,271,367 A, 4,982,014 A and 2,999,846 A, in German published specifications 1 570 703 A, 2 063 050 A, 2 036 052 A, 2 211 956 A and 3 832 396 A, in French patent 1 561 518 A1, in the monograph “H. Schnell, Chemistry and Physics of Polycarbonates, Interscience Publishers, New York 1964, p. 28 ff.; p. 102 ff.”, and in “D. G. Legrand, J. T. Bendier, Handbook of Polycarbonate Science and Technology, Marcel Dekker New York 2000, p. 72ff.”.

In the case of the homopolycarbonates, only one diphenol is used; in the case of copolycarbonates, two or more diphenols are used. The diphenols used, and also all of the other chemicals and auxiliaries added to the synthesis, may be contaminated by the impurities arising during the synthesis, handling and storage thereof. However, it is desirable to use raw materials of the highest possible purity.

The monofunctional chain terminators needed to regulate the molecular weight, such as phenols or alkylphenols, especially phenol, p-tert-butylphenol, isooctylphenol, cumylphenol, the chlorocarbonic esters thereof or acid chlorides of monocarboxylic acids or mixtures of these chain terminators, are either supplied to the reaction together with the bisphenoxide(s) or else added to the synthesis at any time, provided that phosgene or chlorocarbonic acid end groups are still present in the reaction mixture, or, in the case of the acid chlorides and chlorocarbonic esters as chain terminators, provided that sufficient phenolic end groups of the polymer being formed are available. However, it is preferable that the chain terminator(s) is/are added after the phosgeriation procedure at a location/juncture at which phosgene is no longer present but the catalyst has not yet been metered into the system, or that they are metered into the system before the catalyst or in parallel or together with the catalyst.

Any branching agents or branching agent mixtures to be used are added to the synthesis in the same manner, but usually before the chain terminators. Compounds typically used are trisphenols, quaterphenols or acyl chlorides of tri- or tetracarboxylic acids, or else mixtures of the polyphenols or of the acyl chlorides.

Examples of some of the compounds that can be used as branching agents having three, or more than three, phenolic hydroxyl groups are phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tris(4-hydroxyphenyl)benzene, 1,1,1-tri(4-hydroxyphenyl)ethane, tris(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The quantity of the branching agents optionally to he used is from 0.05 mol % to 2 mol %, again based on moles of diphenols used in the particular case.

The branching agents can either be used as initial charge together with the diphenols and the chain terminators in the aqueous alkaline phase or added in solution in an organic solvent before the phosgenation procedure.

All these measures for preparation of the polycarbonates are familiar to those skilled in the art.

Examples of aromatic dicarboxylic acids suitable for the preparation of the polyester carbonates are orthophthalic acid, terephthalic acid, isophthalic acid, tert-butylisophthalic acid, 3,3′-diphenyldicarboxylic acid, 4,4′-diphenyldicarboxylic acid, 4,4-henzophenonedicarboxylic acid, 3,4′-benzophenonedicarboxylic acid, 4,4′-diphenyl ether dicarboxylic acid, 4,4′-diphenyl sulfone dicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of the dicarboxylic acids are the diacyl dihalides and the dialkyl dicarboxylates, especially the diacyl dichlorides and the dimethyl dicarbonates.

Replacement of the carbonate groups by the aromatic dicarboxylic ester groups is in essence stoichiometric, and also quantitative, and the molar ratio of the reactants is therefore also maintained in the finished polyester carbonate. The aromatic dicarboxylic ester groups can be incorporated either randomly or blockwise.

Preferred modes of preparation of the polycarbonates to be used in accordance with the invention, including the polyester carbonates, are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

In the first case the acid derivatives used are preferably phosgene and optionally diacyl dichlorides; in the latter case they are preferably diphenyl carbonate and optionally dicarboxylic diesters. Catalysts, solvents, workup, reaction conditions, etc. have been sufficiently well described and disclosed both for the preparation of polycarbonate and for the preparation of polyester carbonate.

The polycarbonates suitable in accordance with the invention as component A have an OH end group concentration of 50 to 2000 ppm, preferably 200 to 1000 ppm, more preferably 300 to 700 ppm.

The OH end group concentration is determined by photometric means according to Horbach, A.; Veiel, U.; Wunderlich, H., Makromolekulare Chemie 1965, volume 88, p. 215-231.

Preferably, the stoichiometric ratio of the epoxy groups of component C to the phenolic OH groups of component A is at least 1:1, especially at least 1.5:1, preferably at least 2:1.

Useful polyesters in a preferred embodiment are aromatic, and they are further preferably^{,} polyalkylene terephthalates.

In particularly preferred embodiments, these are reaction products of aromatic dicarboxylic acids or reactive derivatives thereof, such as dimethyl esters or anhydrides, and aliphatic, cycloaliphatic or araliphatic diols and also mixtures of these reaction products.

Particularly preferred aromatic polyalkylene terephthalates contain at least 80% by weight, preferably at least 90% by weight, based on the dicarboxylic acid component, of terephthalic acid radicals and at least 80% by weight, preferably at least 90% by weight, based on the diol component, of ethylene glycol and/or butane-1,4-diol radicals.

The preferred aromatic polyalkylene terephthalates may contain, as well as terephthalic acid radicals, up to 20 mol %, preferably up to 10 mol %, of radicals of other aromatic or cycloaliphatic dicarboxylic acids having 8 to 14 carbon atoms or of aliphatic dicarboxylic acids having 4 to 12 carbon atoms, for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred aromatic polyalkylene terephthalates may contain not only ethylene glycol and/or butane-1,4-diol radicals but also up to 20 mol %, preferably up to 10 mol %, of other aliphatic diols having 3 to 12 carbon atoms or cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(4-β-hydroxyethoxyphenyl)propane and 2,2-bis(4-hydroxypropoxyphenyl)propane (DE-A 2 407 674, 2 407 776, 2 715 932).

The aromatic polyalkylene terephthalates may be branched through incorporation of relatively small amounts of tri- or tetrahydric alcohols or tri- or tetrabasic carboxylic acids, for example according to DE-A 1 900 270 and U.S. Pat. No. 3,692,744. Examples of preferred branching agents are trimesic acid, trimellitic acid, trimethylolethane and trimethylolpropane, and pentaerythritol.

Particular preference is given to aromatic polyalkylene terephthalates which have been prepared solely from terephthalic acid and the reactive derivatives thereof (e.g. the dialkyl esters thereof) and ethylene glycol and/or butane-1,4-diol, and to mixtures of these polyalkylene terephthalates.

Preferred mixtures of aromatic polyalkylene terephthalates contain 1% to 50% by weight, preferably 1% to 30% by weight, of polyethylene terephthalate and 50% to 99% by weight, preferably 70% to 99% by weight, of polybutylene terephthalate.

The preferably used aromatic polyalkylene terephthalates have a viscosity number of 0.4 to 1.5 dl/g, preferably 0.5 to 1.2 dl/g, measured in phenol/o-dichlorobenzene (1:1 parts by weight) in a concentration of 0.05 g/ml according to ISO 307 at 25° C. in an Ubbelohde viscometer.

The aromatic polyalkylene terephthalates can be prepared by known methods (see, for example, Kunststoff-Handbuch [Plastics Handbook], volume VIII, p. 695 et seq., Carl-Hanser-Verlag, Munich 1973).

A most preferred component A is aromatic polycarbonate based on bisphenol A.

Component B

Component B consists of B1 and optionally B2. If component B consists of B1 and B2, the proportion of B1 in component B is preferably at least 50% by weight, more preferably at least 80% by weight. Both component B1 and component B2 do not contain any epoxy groups.

Component B1

As component B1 the compositions according to the invention comprise rubber-containing graft polymers, prepared by the bulk polymerization method. It is possible to use a graft polymer of this kind or of a mixture of two or more graft polymers.

In a preferred embodiment, these may be graft polymers of

B1.1) 75% to 95% by weight, preferably 80% to 93% by weight, more preferably 85% to 92% by weight, most preferably 87% to 93% by weight, based on component B1, of a mixture of

B1.1.1) 65% to 85% by weight, preferably 70% to 80% by weight, based on the mixture B1.1, of at least one monomer selected from the group of the vinylarornatics (for example styrene, α-methylstyrene), ring-substituted vinylarornatics (for example p-methylstyrene, p-chlorostyrene) and (C1-C8)-alkyl methacrylates (for example methyl methacrylate, ethyl methacrylate) and

B1.1.2) 15% to 35% by weight, preferably 20% to 30% by weight, based on the mixture B1.1, of at least one monomer selected from the group of the vinyl cyanides (for example unsaturated nitriles such as acrylonitrile and methacrylonitrile), (C1-C8)-alkyl (meth)acrylates (for example methyl methacrylate, n-butyl acrylate, tert-butyl acrylate) and derivatives (for example anhydrides and imides) of unsaturated carboxylic acids (for example maleic anhydride and N-phenylmaleimide)

onto

B1.2) 25% to 5% by weight, preferably 20% to 7% by weight, more preferably 15% to 8% by weight, most preferably 13% to 7% by weight, based on component B1,

of at least one graft base.

The graft base preferably has a glass transition temperature<0° C., preferably<−20° C., more preferably<−60° C.

Unless expressly stated otherwise in the present application, the glass transition temperature is determined for all components by differential scanning calorimetry (DSC) according to DIN EN 61006 (1994 version) at a heating rate of 10 K/min with determination of Tg as the midpoint temperature (tangent method).

The graft particles in component B1 preferably have a median particle size (D50) of 0.1 to 10 μm, preferably of 0.3 to 2 μm, more preferably of 0.4 to 1.5 μm.

The graft particle particle size distribution and values derived therefrom are determined by means of ultracentrifuge measurement (W. Scholtan, H. Lange, Kolloid, Z. and Z. Polymere 250 (1972), 782-796).

Preferred monomers B1.1.1 are selected from at least one of the monomers styrene, α-methylstyrene and methyl methacrylate; preferred monomers B1.1.2 are selected from at least one of the monomers acrylonitrile, maleic anhydride, butyl acrylate and methyl methacrylate. Particularly preferred monomers are B1.1.1 styrene and B1.1.2 acrylonitrile, optionally mixed with butyl acrylate.

Graft bases B1.2 suitable for the graft polymers B1 are, for example, diene rubbers and diene-vinyl block copolymer rubbers and also mixtures of such rubbers.

Preferred graft bases B1.2 are diene rubbers (for example based on butadiene or isoprene), diene-vinyl block copolymer rubbers (for example based on butadiene and styrene blocks), copolymers of diene rubbers with further copolymerizable monomers (for example according to B1.1.1 and B1.1.2) and mixtures of the aforementioned rubber types. Particularly preferred graft bases B1.2 are polybutadiene rubber, styrene-butadiene block copolymer rubbers and mixtures of styrene-butadiene block copolymer rubbers with pure rubber.

The gel content of the graft polymers B1 is preferably 10% to 35% by weight, more preferably 15% to 30% by weight, most preferably 17 to 23% by weight (measured in acetone).

Particularly preferred polymers B 1 are, for example, ABS polymers prepared by free-radical polymerization, which, in a preferred embodiment, contain up to 10% by weight, more preferably up to 5% by weight, most preferably 2% to 5% by weight, based in each case on the graft polymer B 1, of n-butyl acrylate as a constituent of B1.1.2.

As a result of the preparation, graft polymer B1 generally contains free copolymer of B1.1.1 and B1.1.2, i.e. copolymer not chemically bonded to the graft base, which has the feature that it can be dissolved in suitable solvents (e.g. acetone).

Component B1 preferably comprises a free copolymer of B1.1.1 and B1.1.2 having a weight-average molecular weight (Mw) determined by gel permeation chromatography with polystyrene as standard of preferably 50 000 to 250 000 g/mol, more preferably of 70 000 to 200 000 g/mol, more preferably of 80 000 to 170 000 g/mol.

Component B2

The composition may optionally comprise, as a further component B2, rubber-free vinyl (co)polymers, preferably of at least one monomer from the group of the vinylaromatics, vinyl cyanides (unsaturated nitriles), (C1 to C8)-alkyl (meth)acrylates, and unsaturated carboxylic acids and derivatives (such as anhydrides and imides) of unsaturated carboxylic acids.

It is possible to use a rubber-free vinyl (co)polymer of this kind or of a mixture of w or more rubber-free vinyl (co)polymers.

Especially suitable as component B2 are (co)polymers of

B2.1 50% to 99% by weight, preferably 65% to 85% by weight, particularly preferably 70% to 80% by weight based on the (co)polymer 82 of at least one monomer selected from the group of, the vinylaromatics (for example styrene, α-methylstyrene), ring-substituted vinylaromatics (for example p-methylstyrene, p-chlorostyrene) and (C1-C8)-alkyl (meth)acrylates (for example methyl methacrylate, n-butyl acrylate, tert-butyl acrylate) and

B2.2 1% to 50% by weight, preferably 15% to 35% by weight, particularly preferably 20% to 30% by weight based on the (co)polymer B2 of at least one monomer selected from the group of the vinyl cyanides (for example unsaturated nitriles such as acrylonitrile and methacrylonitrile), (C1-C8)-alkyl (meth)acrylates (for example methyl methacrylate, n-butyl acrylate, tert-butyl acrylate), unsaturated carboxylic acids and derivatives of unsaturated carboxylic acids (for example maleic anhydride and N-phenylmaleimide).

These (co)polymers B2 are resinous, thermoplastic and rubber-free. Particular preference is given to the copolymer of B2.1 styrene and B2.2 acrylonitrile.

(Co)polymers B2 of this kind are known and can be prepared by free-radical polymerization, especially by bulk polymerization.

The (co)polymers B2 have a weight-average molecular weight (Mw) determined by gel permeation chromatography with a polystyrene standard of preferably 50 000 to 2 500 000 g/mol, particularly preferably of 70 000 to 200 000 g/mol, particularly preferably of 80 000 to 170 000 g/mol.

Component C

The composition comprises, as component C, at least one block or graft polymer containing structural units derived from styrene and structural units derived from at least one vinyl monomer containing epoxy groups.

In the context of the present application, epoxy groups are understood to mean the following structural units:

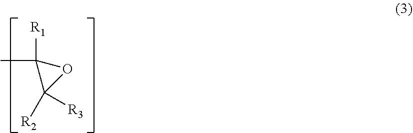

where R1, R2 and R3 are independently hydrogen or methyl, preferably at least two of the R1, R2 and R3 radicals are hydrogen, and more preferably all R1, R2 and R3 radicals are hydrogen.

Such vinyl monomers containing epoxy groups to be used for preparation of the component C are, for example, glycidyl acrylate, glycidyl methacrylate, glycidyl ethacrylate, glycidyl itaconate, allyl glycidyl ether, vinyl glycidyl ether, vinylbenzyl glycidyl ether or propenyl glycidyl ether.

Glycidyl methacrylate is especially preferred.

In a preferred embodiment, component C comprises a polymer prepared by copolymerization of styrene and at least one styrene-copolymerizable vinyl monomer containing epoxy groups.

In a preferred embodiment, in the preparation of these polymers of component C, as well as styrene and the vinyl monomer containing epoxy groups, at least one further vinyl monomer free of epoxy groups which is copolymerizable with these monomers is used. These further vinyl monomers are selected from the group consisting of vinylaromatics (for example α-methylstyrene), ring-substituted vinylaromatics (for example p-methylstyrene, p-chlorostyrene), (C1-C8)-alkyl (meth)acrylates (for example methyl methacrylate, n-butyl acrylate, tert-butyl acrylate), vinyl cyanides (for example acrylonitrile and methacrylonitrile), unsaturated carboxylic acids (for example maleic acid and N-phenylmaleic acid) and derivatives of unsaturated carboxylic acids (for example maleic anhydride and N-phenylmaleimide).

Especially preferably, the further copolyrnerizable vinyl monomer used is acrylonitrile.

In a further preferred embodiment, component C comprises at least one polymer containing structural units derived from styrene, acrylonitrile and glycidyl methacrylate, and in a particularly preferred embodiment a polymer consisting of structural units derived from styrene, acrylonitrile and glycidyl methacrylate.

If, aside from structural units derived from styrene and derived from the vinyl monomer containing epoxy groups, structural units derived from a further vinyl monomer free of epoxy groups, as described above, are additionally present in component C, the weight ratio between the structural units derived from styrene and the structural units derived from the further vinyl monomer is in the range from 99:1 to 50:50, preferably in the range from 85:15 to 60:40.

In a further embodiment, component C contains structural units derived from styrene, acrylonitrile and glycidyl methacrylate, where the weight ratio of the styrene-derived structural units to acrylonitrile-derived structural units is 99:1 to 50:50, preferably 85:15 to 60:40.

In a preferred embodiment, component C comprises a polymer prepared by copolymerization from styrene, acrylonitrile and glycidyl methacrylate, where the weight ratio of styrene to acrylonitrile is 99:1 to 50:50, preferably 85:15 to 60:40.

In the preparation of the polymers of component C, preference is given to observing such conditions that hydrolysis of the epoxy groups is at least largely avoided. Suitable and preferred conditions for this purpose are, for example, low contents of polar solvents such as water, alcohol, acids or bases, and working in solvents from the group of the organic hydrocarbons that are inert toward epoxy groups, for example toluene, ethylbenzene, xylene, high-boiling aliphatics, esters or ethers.

The block or graft polymers are prepared, for example, by free-radically initiated polymerization of styrene, at least one vinyl monomer containing epoxy groups and optionally further copolymerizable epoxy-free vinyl monomers as mentioned above in the presence of a polymer selected from the group consisting of polycarbonate, polyester, polyester carbonate, polyolefin, polyacrylate and polymethacrylate.

These polymers may likewise contain epoxy groups, and these in the case of the polyolefins, polyacrylates and polytnethacrylates are preferably obtained by copolymerization with vinyl monomers containing epoxy groups.

In a particularly preferred embodiment, a block or graft polymer prepared by free-radically initiated polymerization of styrene, glycidyl methacrylate and acrylonitrile in the presence of a polycarbonate, where styrene and acrylonitrile are used in a weight ratio of 85:15 to 60:40, is used.

Block or graft polymers of this kind are obtained, for example, by swelling or dissolving the abovementioned polymer selected from the group consisting of polycarbonate, polyester, polyester carbonate, polyolefin, polyacrylate and polymethacrylate in the monomer mixture of styrene and optionally styrene-copolymerizable vinyl monomers, optionally and preferably including vinyl monomer containing epoxy groups, for which purpose it is optionally also possible to use a preferably nonaqueous cosolvent, and reacting it with an organic peroxide as initiator for a free-radical polymerization by increasing the temperature, followed by melt compounding.

In another embodiment, it is possible to use as component C a block or graft polymer prepared by reaction of a polymer containing structural units derived from styrene arid from a vinyl monomer containing epoxy groups with a polymer containing OH groups, selected from the group consisting of polycarbonate, polyester and polyester carbonate.

In the preparation of the block or graft polymers, it may be the case that not all polymer chains selected from the group consisting of polycarbonate, polyester, polyester carbonate, polyolefin, polyacrylate and polymethacrylate form block or graft polymers with styrene and the optional further vinyl monomers.

Component C in these cases is also understood to mean those polymer mixtures which are obtained by the preparation methods described and in which homopolymers are also present, selected from polycarbonate, polyester, polyester carbonate, polyolefin, polyacrylate and polymethacrylate and the styrene (co)polymers obtained from styrene and the optional further styrene-copolymerizable vinyl monomers.

Component C may also be a mixture of two or more of the components described above.

Component C has a weight ratio of structural elements deriving from styrene to structural elements deriving from epoxy-containing vinyl monomer of 100:1 to 1:1, preferably of 10:1 to 1:1, further preferably of 5:1 to 1:1, most preferably of 3:1 to 1:1.

Component C has an epoxy content measured according to ASTM D 1652-1 (2011 version) in dichloromethane of 0.1% to 5% by weight, preferably 03% to 3% by weight, more preferably 1% to 3% by weight.

Commercially available graft or block polymers which can be used as component C are, for example, Modiper™ CL430-G, Modiper™ A 4100 and Modiper™ A 4400 (each NOF Corporation, Japan). Preference is given to using Modiper™ CL430-G.

Component D

The composition may comprise as component D one or more further additives preferably selected from the group consisting of flame retardants, anti-drip agents, flame retardant synergists, lubricants and demoulding agents (for example pentaerythritol tetrastearate), nucleating agents, antistats, conductivity additives, stabilizers (e.g. hydrolysis, thermal ageing and UV stabilizers, and also transesterification inhibitors and acid/base quenchers), flowability promoters, compatibilizers, further impact modifiers other than component B1 (with or without core-shell structure), further polymeric constituents (for example functional blend partners), fillers and reinforcers (for example carbon fibres, talc, mica, kaolin, CaCO₃) and also dyes and pigments (for example titanium dioxide or iron oxide).

Component D may contain impact modifiers other than component B1. Preference is given to impact modifiers prepared by emulsion polymerization with a core-shell structure, further preferably of the ABS type, i.e. consisting of a core of polybutadiene rubber and a shell of styrene-acrylonitrile copolymer.

If such impact modifiers prepared by emulsion polymerization are present, the proportion thereof is not more than 20% by weight, preferably not more than 10% by weight, based on the sum total of the impact modifiers prepared by emulsion polymerization and component BI.

More preferably, the compositions are free of those impact modifiers prepared by emulsion polymerization.

Further preferably, they do not contain any impact modifiers other component BI,

In a preferred embodiment, the composition is free from flame retardants, anti-drip agents, flame retardant synergists and smoke inhibitors.

In a likewise preferred embodiment, the composition is free from fillers and reinforcing materials.

In a particularly preferred embodiment, the composition is free from flame retardants, anti-drip agents, flame retardant synergists, smoke inhibitors and fillers and reinforcing materials.

In a preferred embodiment, the composition comprises at least one polymer additive selected from the group consisting of lubricants and demoulding agents, stabilizers, tlowability promoters, compatibilizers, dyes and pigments.

In a preferred embodiment, the composition comprises at least one polymer additive selected from the group consisting of lubricants/demoulding agents and stabilizers.

In a preferred embodiment, the composition comprises pentaerythritol tetrastearate as demoulding agent.

In a preferred embodiment, the composition comprises, as stabilizer, at least one representative selected from the group consisting of sterically hindered phenols, organic phosphites, sulfur-based co-stabilizers and organic and inorganic Brønsted acids.

In a particularly preferred embodiment, the composition comprises, as stabilizer, at least one representative selected from the group consisting of octadecyl 3-(3,5-di-tert-butyl-4-hydroxyphenyl)propionate and tris(2,4-di-tert-butylphenyl) phosphite.

In an especially preferred embodiment, the composition comprises, as stabilizer, a combination of octadecyl 3-(3,5-di-tert-butyl-4-hydroxyphenyl)propionate and tris(2,4-di-tert-butylphenyl) phosphite.

Further preferred compositions comprise pentaerythritol tetrastearate as demoulding agent, and a combination of octadecyl 3-(3,5-di-tert-butyl-4-hydroxyphenyl)propionate and tris(2,4-di-tert-butylphenyl) phosphite as stabilizer.

Production of the Moulding Compounds and Mouldings

The compositions according to the invention can be used to produce thermoplastic moulding compounds.

The thermoplastic moulding compounds according to the invention can be produced for example by mixing the respective constituents of the compositions and melt compounding and melt extruding the resulting mixture at temperatures of preferably 200° C. to 320° C., more preferably at 240° C. to 300° C., in customary apparatuses, for example internal kneaders, extruders and twin-shaft screw systems, in a known manner. For the purposes of this application, this process is generally termed compounding.

The term moulding compound therefore means the product that is obtained when the constituents of the composition are compounded in the melt and extruded in the melt.

The individual constituents of the compositions can be mixed in known fashion, either successively or simultaneously, either at about 20° C. (room temperature) or at a higher temperature. It is therefore possible by way of example that some of the constituents are metered into the system by way of the tnain intake of an extruder and that the remaining constituents are introduced subsequently in the compounding process by way of an ancillary extruder.

The moulding compounds feature a low content of monomeric bisphenols, particularly of monomeric bisphenol A. The content of monomeric bisphenols is preferably less than 25 ppm, further preferably less than 20 ppm and more preferably less than 15 ppm.

The invention also provides a process for producing the moulding compounds of the invention.

The moulding compounds of the invention can be used for production of mouldings of any type. These can by way of example be produced by injection moulding, extrusion and blow-moulding processes. Another type of processing is the production of mouldings by thermoforming from prefabricated sheets or films.

It is also possible to meter the constituents of the compositions directly into an injection moulding machine or into an extrusion unit and to process them to give mouldings.

Examples of such mouldings that can be produced from the compositions and moulding compounds according to the invention are films, profiles, housing parts of any type, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automobile sector. The compositions and moulding compounds according to the invention are also suitable for production of the following moulded articles or mouldings: internal fitout parts for rail vehicles, ships, aircraft, buses and other motor vehicles, bodywork components for motor vehicles, housings of electrical equipment containing small transformers, housings for equipment for the processing and transmission of information, housings and cladding for medical equipment, massage equipment and housings therefor, toy vehicles for children, sheetlike wall elements, housings for safety equipment, thermally insulated transport containers, moulded parts for sanitation and bath equipment, protective grilles for ventilation openings and housings for garden equipment.

Further embodiments 1 to 42 of the present invention are described below:

1. Composition for production of a thermoplastic moulding compound, wherein the composition comprises or consists of the following constituents,
A) 30% to 90% by weight of at least one polymer selected from the group consisting of aromatic polycarbonate, aromatic polyester carbonate and aromatic polyester,
B) 5% to 65% by weight of rubber-modified vinyl (co)polymer prepared by the bulk polymerization method which is free of epoxy groups,
C) 0.5% to 10% by weight of a block or graft polymer containing structural elements deriving from styrene and at least one epoxy-containing vinyl monomer,
D) 0% to 20% by weight of one or more further additives,
wherein component C has a weight ratio of structural elements deriving from styrene to those deriving from epoxy-containing vinyl monomer of 100:1 to 1:1.

2. Composition according to embodiment 1, wherein component C has a weight ratio of structural elements deriving from styrene to those deriving from epoxy-containing vinyl monomer of 10:1 to 1:1.

3. Composition according to embodiment 1, wherein component C has a weight ratio of structural elements deriving from styrene to those deriving from epoxy-containing vinyl monomer of 5:1 to 1:1.

4. Composition according to embodiment 1, wherein component C has a weight ratio of structural elements deriving from styrene to those deriving from epoxy-containing vinyl monomer of 3:1 to 1:1.

5. Composition according to any of the preceding embodiments, wherein component A has phenolic OH groups and the stoichiometric ratio of the epoxy groups of component C to the phenolic OH groups of component A is at least 1:1.

6. Composition according to any of the preceding embodiments, wherein component A has phenolic OH groups and the stoichiometric ratio of the epoxy groups of component C to the phenolic OH groups of component A is at least 1.5:1.

7. Composition according to any of the preceding embodiments, wherein component A has phenolic OH groups and the stoichiometric ratio of the epoxy groups of component C to the phenolic OH groups of component A is at least 2:1.

8. Composition according to any of the preceding embodiments, wherein component A has a proportion by weight of phenolic OH groups of 50 to 2000 ppm.

9. Composition according to any of the preceding embodiments, wherein component A has a proportion by weight of phenolic OH groups of 200 to 1000 ppm.

10. Composition according to any of the preceding embodiments, wherein component A has a proportion by weight of phenolic OH groups of 300 to 700 ppm.

11. Composition according to any of the preceding embodiments, wherein component C contains structural units derived from one further styrene-copolymerizable vinyl monomer free of epoxy groups.

12. Composition according to embodiment 11, wherein the weight ratio of the structural units derived from styrene to those derived from the styrene-copolymerizable vinyl monomers free of epoxy groups in component C is in the range from 85:15 to 60:40.

13. Composition according to either of embodiments 11 and 12, wherein component C contains structural units derived from acrylonitrile.

14. Composition according to any of the preceding embodiments, wherein the epoxy-containing vinyl monomer is glycidyl methacrylate.

15. Composition according to any of the preceding embodiments, wherein component C has an epoxy content measured according to ASTM D 1652-11 in dichloromethane of 0.1% to 5% by weight.

16. Composition according to any of preceding embodiments, wherein component C has an epoxy content measured according to ASTM D 1652-11 in dichloromethane of 0.3% to 3% by weight.

17. Composition according to any of preceding embodiments, wherein component C has an epoxy content measured according to ASTM D 1652-11 in dichloromethane of 1% to 3% by weight.

18. Composition according to any of the preceding embodiments, wherein component C is a block or graft polymer prepared by free-radically initiated polymerization of styrene and an epoxy-containing vinyl monomer and optionally further copolymerizable vinyl monomers free of epoxy groups in the presence of a polymer selected from the group consisting of polycarbonate, polyester, polyester carbonate, polyolefin, polyacrylate and polymethacrylate.

19. Composition according to any of embodiments 1 to 17, wherein component C is a block or graft polymer prepared by reaction of an epoxy-containing styrene polymer with a polymer containing OH groups which is selected from the group consisting of polycarbonate, polyester and polyester carbonate.

20. Composition according to any of the preceding embodiments, wherein component D does not comprise any Bronsted-acidic or Bronsted-basic compound.

21. Composition according to any of the preceding embodiments, wherein component C does not contain a graft polymer having core-shell structure or an elastomeric graft base.

22. Composition according to any of the preceding embodiments, wherein component A is aromatic polycarbonate based on bisphenol A.

23. Composition according to any of the preceding embodiments, comprising 40% to 80% by weight of component A, 10% to 50% by weight of component B, 1% to 8% by weight of component C and 0.1% to 15% by weight of component D.

24. Composition according to any of the preceding embodiments, comprising 50% to 75% by weight of component A, 15% to 45% by weight of component B, 2% to 7% by weight of component C and 0.2% to 10% by weight of component D.

25. Composition according to any of the preceding embodiments, wherein component B consists of components B1 and optionally B2 and wherein component B1 is a rubber-containing graft polymer or a mixture of two or more rubber-containing graft polymers, each prepared by the bulk polymerization method, and wherein component B2 is a rubber-free vinyl (co)polymer or a mixture of two or more rubber-free vinyl (co)polymers.

26. Composition according to any of the preceding embodiments, wherein component B contains at least 50% by weight of component B1.

27. Composition according to any of the preceding embodiments, wherein component B contains at least 80% by weight of component B1.

28. Composition according to any of the preceding embodiments, wherein component D comprises at least one impact modifier prepared by emulsion polymerization.

29. Composition according to embodiment 28, wherein the proportion of impact modifiers prepared by emulsion polymerization is not more than 20% by weight, based on the sum total of the impact modifiers prepared by emulsion polymerization and component B 1.

30. Composition according to embodiment 28, wherein the proportion of impact modifiers prepared by emulsion polymerization is not more than 10% by weight, based on the sum total of the impact modifiers prepared by emulsion polymerization and component B1.

31. Composition according to any of the preceding embodiments, free of impact modifiers prepared by emulsion polymerization.

32. Composition according to any of the preceding embodiments, consisting to an extent of at least 80% by weight of constituents A to D.

33. Composition according to any of the preceding embodiments, consisting to an extent of at least 90% by weight of constituents A to D.

34. Composition according to any of the preceding embodiments, consisting of constituents A to D.

35. Moulding compound obtained by compounding the constituents of a composition according to any of embodiments I to 34 at temperatures in the range from 200 to 350° C.

36. Moulding compound according to embodiment 34 wherein the compounding takes place at from 240 to 320° C.

37. Moulding compound according to embodiment 34 wherein the compounding takes place at from 260 to 300° C.

38. Moulding compound according to any of embodiments 35 to 37, containing less than 25 ppm of monomeric bisphenols.

39. Moulding compound according to any of embodiments 35 to 37, containing less than 20 ppm of monomeric bisphenols.

40. Moulding compound according to any of embodiments 35 to 37, containing less than 15 ppm of monomeric bisphenols.

41. Use of a composition according to any of embodiments 1 to 34 or of a moulding compound according to any of embodiments 35 to 40 for production of mouldings.

42. Moulding obtainable from a composition according to any of embodiments 1 to 34 or from a moulding compound according to any of embodiments 35 to 40.

### EXAMPLES

Component A:

Linear polycarbonate based on bisphenol A having a weight-average molecular weight Mw of 29 000 g/mol (determined by GPC in methylene chloride against a BPA-PC standard) and a proportion by weight of phenolic OH groups of 150 ppm.

Component B-1

Blend of

50% by weight of a graft polymer of the ABS type precipitated with magnesium sulfate in an acidic medium, prepared by grafting by the emulsion polymerization method, using potassium peroxodisulfate as polymerization initiator, of 52 parts by weight of a mixture of styrene and acrylonitrile in a % by weight ratio of 72:28 onto 48 parts by weight of a particulate crosslinked polybutadiene rubber having a particle diameter determined by ultracentrifugation of d₅₀=0.3 μm and

50% by weight of a styrene acrylonitrile copolymer prepared by bulk polymerization of styrene and acrylonitrile in a % by weight ratio of 76:24 with a weight-average molecular weight Mw of 100 kg/mol (determined by GPC at 20° C. in tetrahydrofuran with polystyrene as standard). Owing to the nature of the workup method for the graft polymer of the ABS type used in B-1, which does not result in complete removal of the precipitation medium, this graft polymer contains Brønsted-acidic compounds as preparation-related impurity.

Component B-2:

Blend of

50% by weight of a graft polymer of the ABS type precipitated with magnesium sulfate in a basic medium, prepared by grafting by the emulsion polymerization method, using potassium peroxodisulfate as polymerization initiator, of 50 parts by weight of a mixture of styrene and acrylonitrile in a % by weight ratio of 76:24 onto 50 parts by weight of a particulate crosslinked polybutadiene rubber having a particle diameter determined by ultracentrifugation of d₅₀=0.2 μm and

50% by weight of a styrene acrylonitrile copolymer prepared by bulk polymerization of styrene and acrylonitrile in a % by weight ratio of 76:24 with a weight-average molecular weight Mw of 100 kg/mol (determined by GPC at 20° C. in tetrahydrofuran with polystyrene as standard).

Owing to the nature of the workup method for the graft polymer of the ABS type used in B-2, which does not result in complete removal of the precipitation medium, this graft polymer contains Brønsted-basic compounds as preparation-related impurity.

Component B-3

Graft polymer of the ABS type, prepared by the bulk polymerization method, having an A:B:S ratio of 24:9:67% by weight and having a gel content measured as the acetone-insoluble fraction of 20% by weight. The weight-average molecular weight Mw, measured by GPC with polystyrene as standard in dimethylformamide at 20° C., of the free SAN, i.e. that which is not chemically bound to the rubber and is included in the rubber particles in acetone-insoluble form, is 165 kg/mol. The rubber particles contain SAN inclusions and have a median particle diameter determined by ultracentrifugation of d50=0.8 μm.

Component C-1:

Modiper™ CL430-G (NOF Corporation, Japan): graft copolymer containing blocks of polycarbonate and blocks of glycidyl methacrylate-styrene-acrylonitrile terpolymer, which has been obtained by free-radical graft polymerization, initiated by a peroxide, of 30% by weight of a monomer mixture of styrene, acrylonitrile and glycidyl methacrylate in a ratio of 15:6:9% by weight in the presence of 70% by weight of linear polycarbonate based on bisphenol A.

The epoxy content of component C measured according to ASTM D 1652-11 in dichloromethane is 2.4% by weight.

Component C-2:

Fineblend™ SAG 008 (Nantong Sunny Polymer New Material Technology Co. LTD, China):

random terpolynier prepared by polymerization of glycidyl methacrylate, styrene and acrylonitrile. The epoxy content of component C measured according to ASTM D 1652-11 in dichloromethane is 2.4% by weight.

Component D-1:

Pentaerythritol tetrastearate as lubricant/demoulding agent

Component D-2:

Industrial carbon black, Black pearls™ 800 (Cabot Corporation).

Components D-3:

Thermal stabilizer, Irganox™ B900 (mixture of 80% Irgafos™ 168 (tris(2,4-di-tert-butylphenyl) phosphite) and 20% Irganox™ 1076 (2,6-di-tert-butyl-4-(octadecanoxycarbonylethyl)phenol); BASF (Ludwigshafen, Germany).

Component D-4:

Ethylenediamine tetrascetic acid (ETDA); Trilon™ BS, BASF (Ludwigshafen, Germany).

Production and Testing of the Moulding Compounds According to the Invention

The components were mixed in a coperion Werner & Pfleiderer ZSK-25 twin-screw extruder at a melt temperature of 260° C. The mouldings were produced at a melt temperature of 260° C. and a mould temperature of 80° C. in an Arburg 270 E injection-moulding machine. Mouldings for the measurement of surface gloss were produced either at a melt temperature of 260° C. or at a melt temperature of 300° C. Tables 1 and 2 state the particular temperature.

The content of free bisphenol A monomers was determined by means of high-performance liquid chromatography (HPLC) with a diode array (DAD) detector in the pellets produced by means of a twin-shaft extruder. For this purpose, the pellets were first dissolved in dichloromethane and then the polycarbonate was reprecipitated with acetone/methanol. The precipitated polycarbonate and all the components of the compositions that are insoluble in the reprecipitant were filtered off and the filtrates were then concentrated almost to dryness on a rotary evaporator. The residues were analysed by means of HPLC-DAD at room temperature (gradient: acetonitrile/water; stationary phase C-18).

A measure used for the chemical stability was the stress cracking resistance (ESC) in rapeseed oil at room temperature. What was determined was the time before stress cracking-induced fracture failure of a test specimen injection-moulded under the conditions described above with dimensions of 80 mm×10 mm×4 mm, which was subjected to an external edge fibre strain of 2.4% by means of a clamping template and fully immersed in the medium. Measurement was effected according to DIN EN ISO 22088 (2006 version).

Surface gloss was measured in reflection at a viewing angle of 60° with a Haze-Gloss haze/gloss meter from BYK-Gardner GmbH (Geretsried, Germany) to DIN 67530 (1982 version) on test specimens of dimensions 60 mm×40 mm×4 mm injection-tnoulded under the conditions described above. A highly polished injection mould was used.

TABLE 1

| | V1 | V2 | V3 | V4 | V5 | 6 | 7 |
|---|---|---|---|---|---|---|---|
| Component (parts by weight) | | | | | | | |
| A | 70 | 70 | 70 | 70 | 70 | 70 | 70 |
| B-1 | 30 | | | 27 | | | |
| B-2 | | 30 | | | 27 | | |
| B-3 | | | 30 | | | 27 | 27 |
| C-1 | | | | 3 | 3 | 3 | 3 |
| D-1 | 0.75 | 0.75 | 0.75 | 0.75 | 0.75 | 0.75 | 0.75 |
| D-2 | 0.50 | 0.50 | 0.50 | 0.50 | 0.50 | 0.50 | 0.50 |
| D-3 | 0.10 | 0.10 | 0.10 | 0.10 | 0.10 | 0.10 | 0.10 |
| D-4 | | | | | | | 0.003 |
| Content of bisphenol A | 10 | 14 | 17 | 13 | 18 | 9 | n.m. |
| Properties | | | | | | | |
| ESC characteristics, time | 7 | 5 | 30 | 7 | 6 | 54 | 50 |
| before fracture [h] | | | | | | | |
| Improvement in ESC through | | | | 0% | 20% | 80% | 67% |
| addition of C | | | | | | | |
| Gloss at 60° (260° C.) | 102 | 96 | 66 | 90 | 87 | 47 | 61 |
| Reduction in gloss through | | | | 12% | 10% | 29% | 8% |
| addition of C and D-4 | | | | | | | |

n.m.: not measured

The mouldings produced from the compositions according to the invention as per Examples 6 and 7 feature an advantageous combination of good chemical resistance and low surface gloss. This becomes obvious by comparison with Comparative Example 3 which does not contain component C, and in comparison with Comparative Examples V4 and V5 which do contain component C but do not contain a graft copolymer produced by the bulk polymerization method as component B. Only in the case of use of inventive component B (Example 6 compared to Comparative Example 3) is a significant reduction in gloss and a distinct improvement in chemical resistance achieved through the addition of component C (compare V1 with V4 and V2 with V5),

A comparison of the fundamentally inventive examples 6 and 7 makes it clear that it is advantageous when the compositions do not contain any acid as component D.

The improvement in chemical resistance and reduction in surface gloss are accompanied by a low content of monomeric bisphenol A.

TABLE 2

| | V8 | 9 | V10 |
|---|---|---|---|
| Component (parts by weight | | | |
| A | 70 | 70 | 70 |
| B-3 | 30 | 25 | 25 |
| C-1 | | 5 | |
| C-2 | | | 5 |
| D-1 | 0.75 | 0.75 | 0.75 |
| D-2 | 0.50 | 0.50 | 0.50 |
| D-3 | 0.10 | 0.10 | 0.10 |
| Content of bisphenol A | 20 | 11 | 20 |
| Properties | | | |
| ESC characteristics, time | >30 | >30 | >30 |
| before fracture [h] | | | |
| Gloss at 60° (300° C.) | 99 | 83 | 94 |
| Reduction in gloss through | | 16% | 5% |
| addition of C | | | |

The mouldings produced from inventive composition 9 likewise feature good chemical resistance and low surface gloss. Noninventive component C-2 does not achieve a sufficient reduction in the level of gloss (V10).

Inventive composition 9 is also advantageous with regard to the content of free bisphenol A.

1.-15. (canceled)

16. A composition for production of a thermoplastic moulding compound, comprising of the following contintuents:
A) 30% to 90% by weight of at least one polymer selected from the group consisting of aromatic polycarbonate, aromatic polyester carbonate and aromatic polyester,
B) 5% to 65% by weight of rubber-modified vinyl (co)polymer prepared by the bulk polymerization method and which is free of epoxy groups,
C) 0.5% to 10% by weight of a block or graft polymer containing structural elements deriving from styrene and at least one epoxy-containing vinyl monomer,
D) 0% to 20% by weight of one or more further additives,
wherein component C has a weight ratio of structural elements deriving from styrene to those deriving from epoxy-containing vinyl monomer of 100:1 to 1:1.

17. The composition according to claim 16, wherein component A has a proportion by weight of phenolic OH groups of 50 to 2000 ppm.

18. The composition according to claim 16, wherein component C contains structural units derived from at least one further styrene-copolymerizable vinyl monomer free of epoxy groups.

19. The composition according to claim 18, wherein the weight ratio of the structural units derived from styrene to those derived from styrene-copolymerizable vinyl monomer free of epoxy groups in component C is in the range from 85:15 to 60:40.

20. The composition according to claim 18, wherein component C contains structural units derived from acrylonitrile

21. The composition according to claim 16, wherein the epoxy-containing vinyl monomer is glycidyl methacrylate.

22. The composition according to claim 16, wherein component C has an epoxy content measured according to ASTM D 1652-11 in dichloromethane of 0.1% to 5% by weight.

23. The composition according to claim 16, wherein component C is a block or graft polymer prepared by free-radically initiated polymerization of styrene and an epoxy-containing vinyl monomer and optionally further copolymerizable vinyl monomers free of epoxy groups in the presence of a polymer selected from the group consisting of polycarbonate, polyester, polyester carbonate, polyolefin, polyacrylate and polymethacrylate.

24. The composition according to claim 16, wherein component C is a block or graft polymer prepared by reaction of an epoxy-containing styrene polymer with a polymer containing OH groups which is selected from the group consisting of polycarbonate, polyester and polyester carbonate.

25. The composition according to claim 16, which is free of impact modifiers produced by emulsion polymerisation.

26. The composition according to claim 16, wherein component D does not comprise any Brönsted-acidic or Brönsted-basic compound.

27. A moulding compound obtained by compounding the constituents of the composition

16. g to claim 16 at temperatures in the range from 200 to 350° C.

28. The moulding compound according to claim 27, containing less than 20 ppm of monomeric bisphenols.

29. A method comprising providing the composition according to claim 16 and producing a moulding.

30. A moulding obtained from the composition according to claim 16.
